(19) United States
(12) Patent Application Publication
(10) Pub. No.: US 2013/0169694 A1
(43) Pub. Date: Jul. 4, 2013

(54) DISPLAY APPARATUS

(71) Applicants: Fu-Hao Chen, Kaohsiung City (TW); Wu-Li Chen, Changhua County (TW); Wei-Ting Yen, Taipei City (TW); Jian-Chiun Liou, Kaohsiung City (TW); Chao-Hsu Tsai, Hsinchu City (TW)

(72) Inventors: Fu-Hao Chen, Kaohsiung City (TW); Wu-Li Chen, Changhua County (TW); Wei-Ting Yen, Taipei City (TW); Jian-Chiun Liou, Kaohsiung City (TW); Chao-Hsu Tsai, Hsinchu City (TW)

(73) Assignee: INDUSTRIAL TECHNOLOGY RESEARCH INSTITUTE, Hsinchu (TW)

(21) Appl. No.: 13/467,983

(22) Filed: May 9, 2012

(30) Foreign Application Priority Data
Dec. 29, 2011 (TW) 100149592

(51) Int. Cl. G09G 5/10; G06F 3/038; G09F 13/18

(52) U.S. Cl. 345/690; 362/602; 345/214

(57) ABSTRACT

A display apparatus including a backlight module and a transmissive display panel is provided. The backlight module includes a light guide plate, a patterned light scattering structure, and a light emitting device. The light guide plate has a first surface, a second surface opposite to the first surface, and a light incident surface connecting the first surface and the second surface. The patterned light scattering structure is disposed on the light guide plate or inside the light guide plate. The patterned light scattering structure includes a plurality of light scattering strips. The light emitting device is configured to emit an illumination light and the light incident surface is disposed on the path of the illumination light. The light scattering strips are configured to scatter the illumination light. The transmissive display panel is disposed beside the backlight module. The first surface faces the transmissive display panel.

### CROSS-REFERENCE TO RELATED APPLICATION

This application claims the priority benefit of Taiwan application serial no. 100149592, filed on Dec. 29, 2011. The entirety of the above-mentioned patent application is hereby incorporated by reference herein and made a part of this specification.

### BACKGROUND

1. Technical Field

The disclosure relates to a display apparatus.

2. Related Art

Along with development of display technology, display devices with better image quality, richer color effect and better performance are continuously developed. In recent years, a stereoscopic display technology has extended from cinema applications to home display applications. The year of 2010 has been set internationally as the first year of stereoscopic display. According to statistical projection, the future global stereoscopic display market may expect an annual increase of, on an average, 95%. Hence, many large display manufacturers successively enter the stereoscopic display market. Driven by such a demand, a flat display device has entered another era, which is an era of stereoscopic display.

A key feature of the stereoscopic display technology is to provide a left eye and a right eye of a user to respectively view the left-eye images and the right-eye images of different viewing angles. Hence, according to the conventional stereoscopic display technology, the user generally wears a special pair of glasses to filter the left-eye images and the right-eye images.

However, wearing the special pair of glasses generally causes a great deal of inconveniences, especially for a myopic or hyperopia user who needs to wear corrective lens glasses. The extra pair of special glasses may cause discomfort and inconvenience. Therefore, a naked-eye stereoscopic display technology becomes one of the key focuses in researches and developments. A typical naked-eye stereoscopic display mainly uses a parallax barrier or a lenticular film to converge the image lights respectively at a plurality of different viewing zones. The images of the different viewing zones are respectively images of different viewing angles. When the left eye and the right eye of the user are respectively located at two different viewing zones, the user can view a stereoscopic image.

However, a parallax barrier may block a portion of the lights, easily causing a substantial reduction of brightness. Moreover, although a lenticular film may achieve a higher light efficiency, the display device is unable to switch between a two-dimensional image display mode and a three-dimensional image display mode.

### SUMMARY

An exemplary embodiment of the disclosure provides a display apparatus that comprises a backlight module and a transmissive display panel. The backlight module comprises a light guide plate, a patterned light scattering structure and a light emitting device. The light guide plate comprises a first surface, a second surface opposite to the first surface, and a light incident surface connecting the first surface and the second surface. The patterned light scattering structure is disposed on the light guide plate or inside the light guide plate, wherein the patterned light scattering structure comprises a plurality of light scattering strips. The light emitting device is configured to emit an illumination light, wherein the light incident surface is disposed on a transmission path of the illumination light, and the plurality of light scattering strips is configured to scatter the illumination light. The transmissive display panel is disposed on one side of the backlight module, wherein the first surface faces towards the transmissive display panel, and the transmissive display panel comprises a plurality of pixel groups, each of the plurality of pixel groups comprises a plurality of pixel columns, and the illumination light, after being scattered by the plurality of light scattering strips and passing through the plurality of pixel groups, respectively converges at a plurality of viewing zones.

Another exemplary embodiment of the disclosure provides a display apparatus. The display apparatus comprises a backlight module and a transmissive display panel. The backlight module comprises a light guide plate, a patterned electric-variable light scattering structure and a light emitting device. The light guide plate comprises a first surface, a second surface opposite to the first surface, and a light incident surface connecting the first surface and the second surface. The patterned electric-variable light scattering structure is disposed over the light guide plate or inside the light guide plate, wherein the patterned electric-variable light scattering structure comprises a plurality of electric-variable light scattering strips, and each of the plurality of electric-variable scattering strips is configured to switch between a scattered state and a transparent state according to variation of voltage applied on each of the plurality of electric-variable scattering strips. The light emitting device is configured to emit an illumination light, wherein the light incident surface is disposed on a transmission path of the illumination light, and the plurality of electric-variable scattering strips is in the scattered state to scatter the illumination light. The transmissive display panel is disposed on one side of the backlight module, wherein the first surface faces towards the transmissive display panel.

Another exemplary embodiment of the disclosure provides a display apparatus, which comprises a backlight module, a transmissive display panel and a control unit. The backlight module comprises a substrate and a plurality of light self-emitting structures, and these light self-emitting structures are disposed on the substrate and emit an illumination light. The transmissive display panel is disposed on one side of the back light module. The control unit is electrically connected to the plurality of light self-emitting structures and the transmissive display panel, wherein the control unit divides the plurality of light self-emitting structures into N groups of light self-emitting structures, wherein N is a positive integer, and the transmissive display panel comprises a plurality of pixel groups and each of the plurality of pixel groups comprises a plurality of pixel columns. The illumination light emitted by each of the plurality of light self-emitting structures converges at a plurality of viewing zones after passing through the plurality of pixel groups.

The disclosure and certain merits provided by the disclosure can be better understood by way of the following exemplary embodiments and the accompanying drawings, which are not to be construed as limiting the scope of the disclosure.

### BRIEF DESCRIPTION OF THE DRAWINGS

FIG. 1A is a schematic diagram showing a cross-sectional view of a display apparatus according to an exemplary embodiment of the disclosure.

FIG. 1B is a top view diagram of the backlight module in FIG. 1A.

FIG. 1C illustrates the pixels of a transmissive display panel in FIG. 1A.

FIG. 2 is a schematic top view diagram of a backlight module according to another exemplary embodiment of the disclosure.

FIG. 3 is a cross-sectional view diagram of a backlight module according to another exemplary embodiment of the disclosure.

FIG. 4 is a cross-sectional view diagram of a backlight module according to another exemplary embodiment of the disclosure.

FIG. 5 is a cross-sectional view diagram of a backlight module according to another exemplary embodiment of the disclosure.

FIGS. 6A and 6B are cross-sectional view diagrams of a display apparatus according to another exemplary embodiment of the disclosure.

FIGS. 7A and 7B are cross-sectional view diagrams of a display apparatus according to another exemplary embodiment of the disclosure.

FIG. 8 is a cross-sectional view diagram of a backlight module according to another exemplary embodiment of the disclosure.

FIGS. 9A and 9B are cross-sectional view diagrams of a display apparatus according to another exemplary embodiment of the disclosure.

FIG. 9C is a top view diagram of the backlight module in FIGS. 9A and 9B.

FIG. 10 is a wave diagram of another exemplary embodiment of a display apparatus in FIGS. 9A and 9B.

FIG. 11 is a schematic, cross-sectional view diagram of a display apparatus according to another exemplary embodiment of the disclosure.

### DETAILED DESCRIPTION OF DISCLOSED EMBODIMENTS

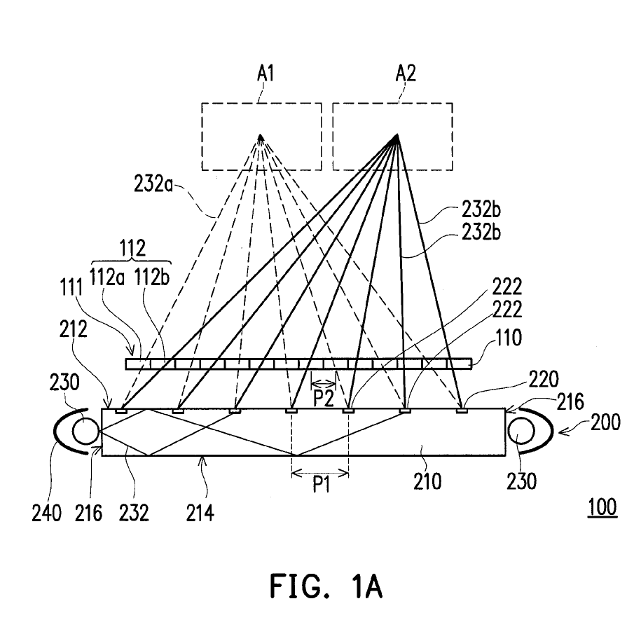

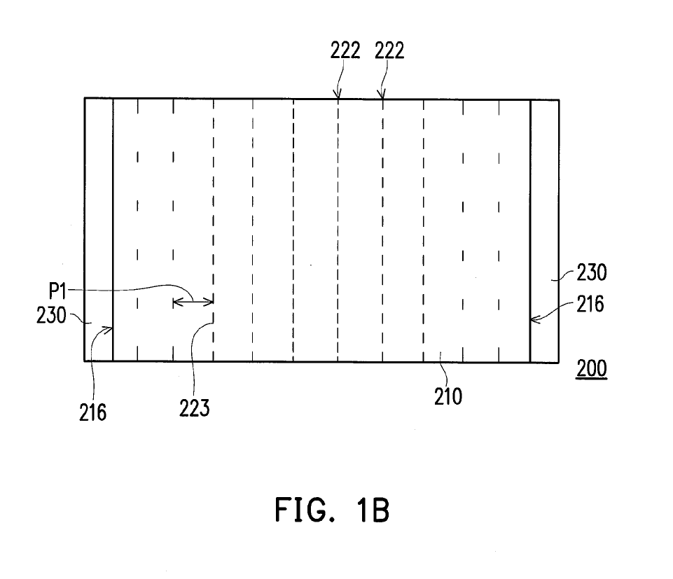

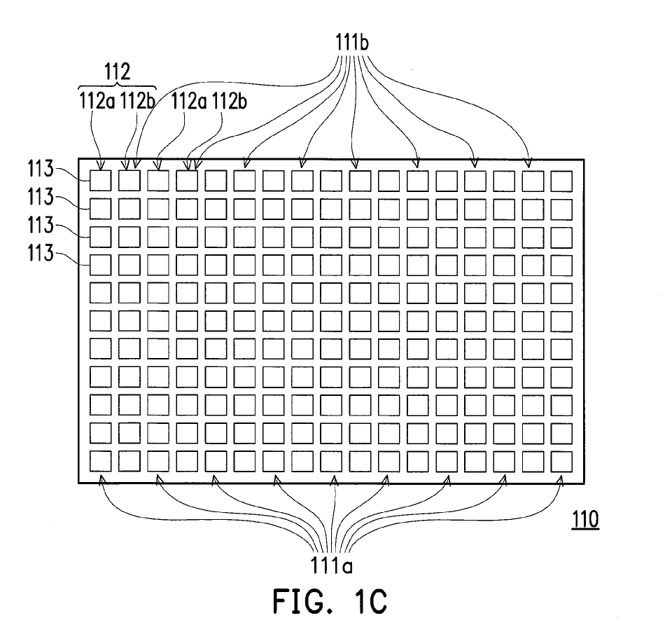

FIG. 1A is a schematic diagram showing a cross-sectional view of a display apparatus according to an exemplary embodiment of the disclosure, FIG. 1B is a top view diagram of the backlight module in FIG. 1A, while FIG. 1C illustrates the pixels of a transmissive display panel in FIG. 1A. In FIG. 1B, the lampshade in FIG. 1A is omitted to illustrate the position of the light emitting device. Referring to FIGS. 1A and 1B, the display apparatus 100 of this exemplary embodiment comprises a backlight module 200 and a transmissive display panel 110. The backlight module 200 comprises a light guide plate 210, a patterned scattering structure 220 and at least a light emitting device 230 (this embodiment, as illustrated in FIG. 1A, is exemplified with two light emitting devices 230). The light guide plate 210 comprises a first surface 212, a second surface 214 opposite to the first surface 212, and at least a light incident surface 216 (this embodiment, as illustrated in FIG. 1A, is exemplified with two light incident surfaces 216) connecting the first surface 212 and the second surface 214. The patterned light scattering structure 220 is disposed over the light guide plate 210 or inside the light guide plate 210. In this exemplary embodiment, the patterned light scattering structure 220 is disposed at the first surface 212. However, in other exemplary embodiments, the patterned light scattering structure 220 may be disposed on the second surface 214. In yet other exemplary embodiments, the patterned light scattering structure 220 may be disposed between the first surface 212 and the second surface 214.

Additionally, the patterned light scattering structure 220 comprises a plurality of light scattering strips 222, and each light scattering strip 222 may comprise scattering particles, a holographic scattering structure, a surface microstructure, a light scattering layer or a combination thereof. The scattering particles comprise, for example, inorganic particles or polymer particles that scatter lights. The inorganic particles are, for example, silicon dioxide (SiO₂) particles, titanium dioxide particles, while a material of the polymer particles comprises, for example, polyethylene terephthalate (PET), polymethhyl methacrylate (PMMA), polycarbonate (PC) or a combination thereof. The dopant concentration, the index of refraction and the particle size of these particles alter the haze of the light scattering strips 222, and the design parameters may be adjusted according to the actual requirements, so as to adjust the haze of the light scattering strips 222. The method in forming a holographic scattering structure comprises applying mutual interferences of two highly coherent light beams to form a pattern corresponding to the light scattering strips 222 on a light sensitive film. The light shape of one of the two highly coherent light beams is the light shape of the light scattering strips 222 of the backlight module 200, for example, a light shape of a directional light of a particular direction or Lambertian light shape. Another light beam is a reference light, for example a parallel light or a spherical light. After a pattern is formed on the light sensitive film, the pattern is then formed on the light guide plate 210 via the replica molding method, so that the light scattering strips 222 are formed on the light guide plate 210. Further, in one exemplary embodiment, the light scattering layer comprises a coating material and the scattering particles that are doped in the coating material. The film thickness of the light scattering layer is, for example, 25 microns to 50 microns. The difference in the index of refraction between the scattering particles and the coating material is less than 40% (for example, the difference in the index of refraction is less than 0.05), and the particle diameter is, for example, 16 microns to 30 microns.

In the exemplary embodiment of the disclosure, each light scattering strips 222 is, for example, a rough surface structure configured on the first surface 212 (or the second surface 214), or a light scattering layer on the first surface 212 (or the second surface 214). The light scattering layer, for example, is formed with light scattering particles or a light scattering material. However, in other exemplary embodiments, each light scattering strip 222 may be a light scattering layer inside the light guide plate 210, for example, a light scattering layer formed with light scattering particles or a light scattering material.

The light emitting device 230 is configured to emit an illumination light 232 and the light incident surface 216 is disposed on the transmission path of the illumination light 232. In the exemplary embodiment, the light emitting device 230 is disposed at a side of the light incident surface 216. Further, these light scattering strips 222 is configured to scatter the illumination light 232. In this exemplary embodiment, the light emitting device 230 is, for example, a cold cathode fluorescent lamp (CCFL). However, in other exemplary embodiments, at least one light-emitting diode (LED) is used to replace the cold cathode fluorescent lamp. Further, in this exemplary embodiment, the backlight module 200 further comprises at least one reflective mask 240 (this embodiment is exemplified with two reflective masks 240). The reflective mask 240 is disposed at one side of the light emitting device 230 to reflect the illumination light emitted from the light emitting device 230 to the light incident surface 216.

In the exemplary embodiment, each light scattering strip 222 comprises a plurality of light scattering patterns 223 that are spaced apart and arranged along a straight line. These light scattering patterns 223 are shaped as line segments, for example. However, in other exemplary embodiments, the light scattering strips 222 are shaped as continuous and uninterrupted strips.

After the illumination light 232 emitted from the light emitting device 230 enters the light guide plate 210 through the light incident surface 216, the illumination light 232 is continuously being totally reflected by the first surface 212 and the second surface 214 and to be confined in the light guide plate 210. However, the patterned light scattering structures 220 completely destroy the total reflection. Based on the light scattering theory, the illumination light 232 is emitted from the patterned light scattering structure 220 through the first surface 212. Accordingly, each light scattering strip 222 generates a line shape light source.

In the exemplary embodiment, the farther away from the light emitting device 230, the number density of the light scattering patterns 223 is higher. Accordingly, the light flux at the light scattering strips 222 that are closer to the light emitting device 230 approaches to the light flux at the light scattering strips 222 that are farther away from the light emitting device 230. In this case, these light scattering strips 222 on the entire light guide plate 210 can generate a line shape light source with a more uniform brightness. In this exemplary embodiment, the light emitting devices 230 are disposed at the two corresponding sides of the light guide plate 210. Hence, the number density of these light scattering patterns 223 gradually increases from the two sides of the light guide plate 210 to the center of the light guide plate 210. In other exemplary embodiments, the light emitting device 230 may be disposed at one side of the light guide plate. Alternatively speaking, the light guide plate 210 has only one light incident surface 216 and the number density of these light scattering pattern 223 gradually increase from the one side near the light incident surface 216 toward the one side far away from the light incident surface 216. Moreover, in this exemplary embodiment, these light scattering strips 222 are spaced apart at equal intervals; in other words, the pitches between two neighboring light scattering strips 222 are substantially the same.

The transmissive display panel 110 is disposed at one side of the backlight module 200, wherein the first surface 212 faces towards the transmissive display panel 110. The transmissive display panel 110 comprises a plurality of pixel groups 111, each pixel group 111 comprises multiple columns of pixels 112. The plurality of pixel groups 111 is M pixel groups, for example, wherein M is a positive integer greater than or equal to 2. Further, two neighboring pixel columns 112 in each pixel group 111 are disposed therebetween with M-1 pixel columns 112 of other M-1 pixel groups 111. In the exemplary embodiment, M=2; in other words, the transmissive display panel 110 comprises two pixel groups 111, wherein all the pixel columns 112a on the transmissive display panel forms one pixel group 111a, all the pixel columns 112b on the transmissive display panel 110 form another pixel group 111b, and the pixel columns 112a and the pixel columns 112b are alternately arranged.

The illumination light 232, after being scattered by these light scattering strips 222 and passing through these pixel groups 111, is converged at a plurality of viewing zones. FIG. 1A is exemplified by two viewing zones A1 and A2. In this exemplary embodiment, the illumination light 232 scattered by these light scattering strips 222 is converged at the same viewing zone after passing through the same pixel group 111. More specifically, in the exemplary embodiment, the pitch (the cycle) P1 of the light scattering strips 222 is approximately two times greater than the pitch P2 (cycle) of the pixel columns 112. A portion of the illumination light 232a scattered by the light scattering strips 222 passes through one pixel group 111a and converges at the viewing zone A1, while a portion of the illumination light 232b scattered by the light scattering strips 222 passes through another pixel group 111b and converges at the viewing zone A2. In the exemplary embodiment, these light scattering strips 222 and these pixel columns 112 are substantially parallel. However, in other exemplary embodiments, these light scattering strips 222 are inclined with respect to the pixel columns 112.

The M pixel groups 111 respectively display M images of different viewing angles. In the exemplary embodiment, the pixel columns 112a display the image of a first viewing angle, and the pixel columns 112b display the image of a second viewing angle, wherein the first viewing angle image and the second viewing angle image are images of two different viewing angles. Accordingly, when the left eye and the right eye of a user are respectively at the viewing zone A1 and the viewing zone A2, the left eye can view the image of the first viewing angle, while the right eye can view the image of second viewing angle, and the parallax between the first viewing angle image and the second viewing image allows the brain of the user to sense a stereoscopic image. This type of stereoscopic display mode can be called as a spatially multiplexing mode.

Since the display apparatus 100 of the exemplary embodiment applies not the parallax barrier but the light scattering strips 222 to form the line shape light source for generating the stereoscopic display effect, the brightness of the stereoscopic image generated by the display apparatus 100 is higher than the brightness of the stereoscopic image generated by a parallax barrier. Further, the problem of brightness decay due to the light shielding effect of a parallax barrier is obviated.

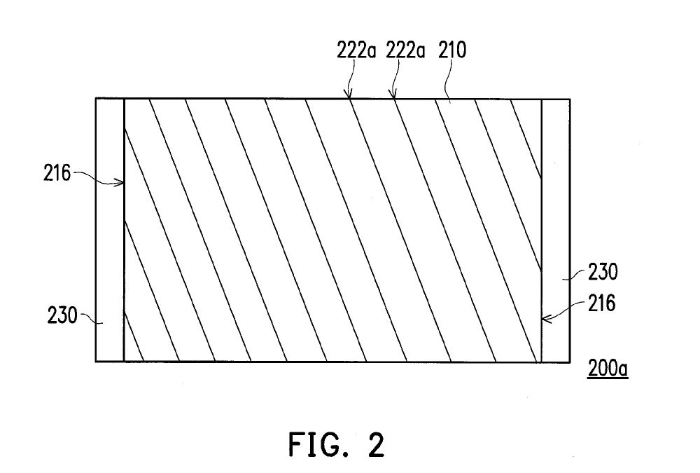

FIG. 2 is a top view of a backlight module according to another exemplary embodiment of the disclosure. Referring to FIG. 2, the backlight module 200a of this exemplary embodiment is similar to the backlight module 200 in FIG. 1B, and the difference between the two backlight modules is discussed below. In the backlight module 200a of this exemplary embodiment, the light scattering strips 222a are inclined with respect to the pixel columns 112 of the transmissive display panel (such as the transmissive display panel 110 of FIG. 1C). Further, in this exemplary embodiment, these light scattering strips 222a are also inclined with respect to the light emitting device 230.

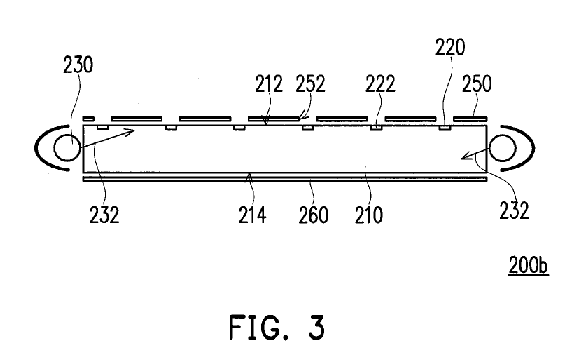

FIG. 3 is a cross-section view of a backlight module according to another exemplary embodiment of the disclosure. Referring to FIG. 3, the backlight module 200b of this exemplary embodiment is similar to the backlight module 200 of FIG. 1A and the difference between the two backlight modules is discussed below. In this exemplary embodiment, the backlight module 200b further comprises a reflection sheet 250 covering the first surface 212. The reflection sheet 250 comprises a plurality of transparent opening 252 respectively exposing the light scattering strips 222. The illumination light 232 scattered by the light scattering strips 222 is transmitted to the transmissive display panel 110 through these transparent openings 252 (as illustrated in FIG. 1A). Moreover, the backlight module 200b in this exemplary embodiment further comprises another reflection sheet 260, covering the second surface 214. The reflection sheet 250 and the reflection sheet 260 reflect the illumination light 232 back to the light guide plate 210. The reusing of light energy is thereby achieved and the light efficiency of the backlight module 200b is enhanced. Further, in the exemplary embodiment, the transparent openings 252 of the reflection sheet 250 face toward the light scattering strips 222. Hence, the illumination light, emitting out of the light guide plate 210 from any region other than the light scattering strips 222 in which the clarity of the stereoscopic image is reduced, can be obviated.

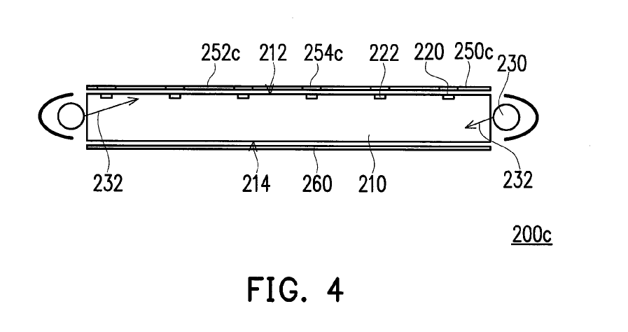

FIG. 4 is a cross-section diagram of a backlight module according to another exemplary embodiment. Referring to FIG. 4, the backlight module 200c of this exemplary embodiment is similar to the backlight module 200b of FIG. 3, and the difference between the two backlight modules is discussed below. In the backlight module 200c of this exemplary embodiment, the reflection sheet 250c covers the first surface 212 and the reflection sheet 250c comprises a patterned reflection region 252c and a patterned transparent region 254c, wherein the patterned reflection region 252c covers the region other than the positions of the patterned light scattering structure 220, and the function of patterned reflection region 252c is substantially the same as the function of the reflection sheet 250. Moreover, the patterned transparent region 254c face directly towards the patterned light scattering structures 220, and the illumination light 232 scattered by the patterned light scattering structures 220 penetrates through the patterned transparent region 254c and transmits to the transmissive display panel 110 (as illustrated in FIG. 1A). In this exemplary embodiment, the patterned transparent region 254c is formed with a transparent material, for example, while the patterned reflection region 252c is formed with a reflective material.

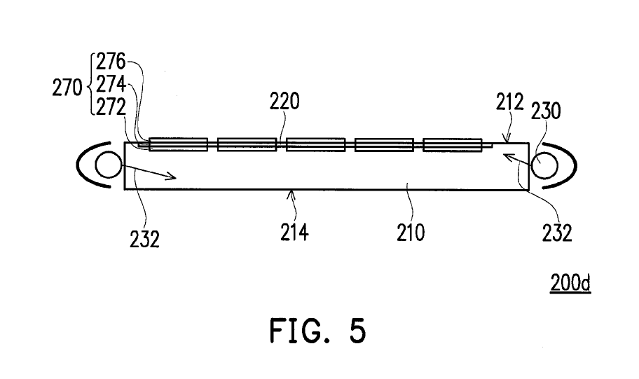

FIG. 5 is a cross-sectional view of a backlight module according to another exemplary embodiment of the disclosure. The backlight module 200d of this exemplary embodiment is similar to the backlight module 200 of FIG. 1A, and the difference between the two backlight modules is discussed below. The backlight module 200d further comprises an electric-variable light scattering structure 270, disposed on the light guide plate 210 or inside the light guide plate 210 (FIG. 5 is exemplified by a disposition of the electric-variable light scattering structure 270 on the first surface 212 of the light guide plate 210). The electric-variable light scattering structure 270 is distributed at least in the regions other than the patterned light scattering structure (FIG. 5 is exemplified by distributing the electric-variable light scattering structure 270 in a part of the regions other than the patterned light scattering structure). The electric-variable light scattering structure 270 is configured to switch between a scattered state and a transparent state according to the variation of voltage applied on the electric-variable light scattering structures 270.

When the electric-variable light scattering structure 270 are in a scattered state, the patterned light scattering structure 220 and the electric-variable light scattering structure 270 form an entire scattering surface for scattering the illumination light 232 to form a plane light source. The illumination light 232 from the plane light source will not converge at a particular viewing zone. Instead, it is disturbed in the space in front of the display apparatus. Hence, all the pixels 113 (as illustrated in FIG. 1C) of the transmissive display panel 110 display a two-dimension image, allowing the display apparatus to be in a two-dimensional image display mode.

When the electric-variable light scattering structure 270 are in a transparent state, the patterned light scattering structure 220 scatters the illumination light 232, while the electric-variable light scattering structure 270 totally reflects the illumination light 232. This effect approaches to the effect of which the first surface 212 is not disposed with the patterned light scattering structure 220, as shown in FIG. 1A. In the meantime, the backlight module 200d may form a plurality of line shape light sources. Accordingly, the pixel columns 112a and the pixel columns 112b respectively display images of different viewing angles, and the display apparatus is in a three-dimensional image display mode.

Further, when a portion of the electric-variable light scattering structure 270 is in a scattered state, while another portion of the electric-variable light scattering structure 270 is in transparent state, the region that shows the scattered state provides the plane light source, while the region that shows the transparent state provides a plurality of line shape light source. Herein, each pixel 113 (as illustrated in FIG. 1C) of the transmissive display panel 110 that corresponds to the region of the plane light source displays a two-dimensional image. On the other hand, the pixel columns 112a and the pixel columns 112b, corresponding to the plurality of line shape light sources, in the regions of the transmissive display panel 110 respectively display images of different viewing angles to display a stereoscopic image. Accordingly, the region of the transmission type display panel, corresponding to the plane light source, displays a two-dimensional image, while the regions of the transmissive display panel 110, corresponding to the plurality of line shape light sources, display a three-dimensional image. Alternatively speaking, a region of the display apparatus is in a two-dimensional display mode, while another region is in a three-dimensional display mode.

In this exemplary embodiment, the electric-variable light scattering structure 270 comprise a first electrode layer 272, an electric-variable medium layer 274 and a second electrode layer 276. The first electrode layer 272 is disposed on the first surface 212, and the electric-variable medium layer 274 is disposed on the first electrode layer 272 and between the first electrode layer 272 and the second electrode layer 276. In this exemplary embodiment, the first electrode layer 272 and the second electrode layer are, for example, transparent electrodes. The electric-variable medium layer 274 is configured to switch between a scattered state and a transparent state according to variation of voltage applied on the electric-variable medium layer 274. Further, in this exemplary embodiment, the electric-variable medium layer 274 is, for example, a polymer dispersed liquid crystal (PDLC) layer; accordingly, when there is no voltage difference between the first electrode layer 272 and the second electrode layer 276, the electric-variable medium layer 274 is in a scattered state for the electric-variable light scattering structure to be in a scattered state. When there is a voltage difference between the first electrode layer 272 and the second electrode layer 276 which is greater than a certain degree, the electric-variable medium layer 274 is in a transparent state for the electric-variable light scattering structures 270 to be in a transparent state.

In another exemplary embodiment, the electric-variable medium layer 274 may comprise a polymer stabilized cholesteric texture (PSCT) liquid crystal. Herein, when there is no voltage difference between the first electrode layer 272 and the second electrode layer 276, the electric-variable medium layer 274 is in a transparent state for the electric-variable scattering structure to be in a transparent state. When there is a voltage difference between the first electrode layer 272 and the second electrode layer 276 which is greater than a certain degree, the electric-variable medium layer 274 is in a scattered state for the electric-variable light scattering structures 270 to be in a scattered state.

In other exemplary embodiments, the electric-variable light scattering structures 270 may simultaneously distributed in the region where the patterned light scattering structure are and in the region other than the region of the patterned light scattering structure 220, wherein the patterned light scattering structures 220 may be disposed over the first surface 212, on the second surface 214 or between the first surface 212 and the second surface 214, and the electric-variable light scattering structures 270 may be disposed on the first surface 212, on the second surface 214 or between the first surface 212 and the second surface 214. Accordingly, when the electric-variable light scattering structure 270 is in a scattered state, a plane light source is also generated. When the electric-variable light scattering structure 270 is in a transparent state, a plurality of line shape light source is generated.

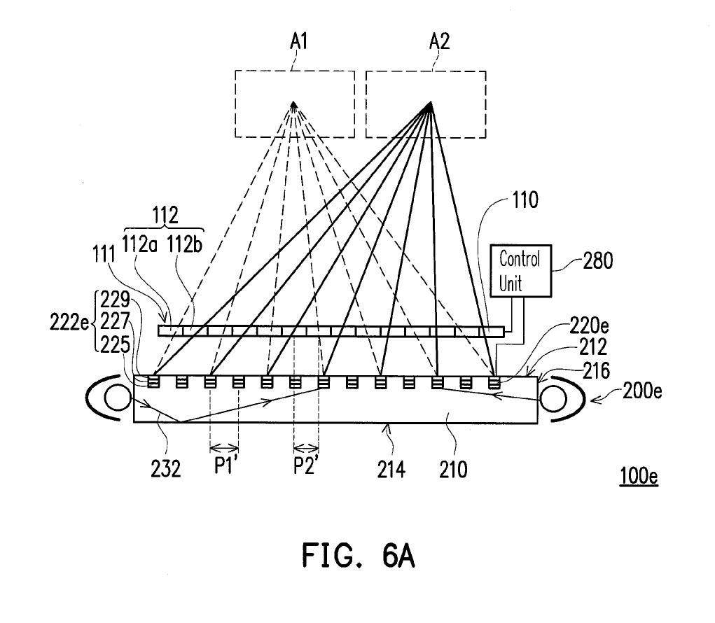

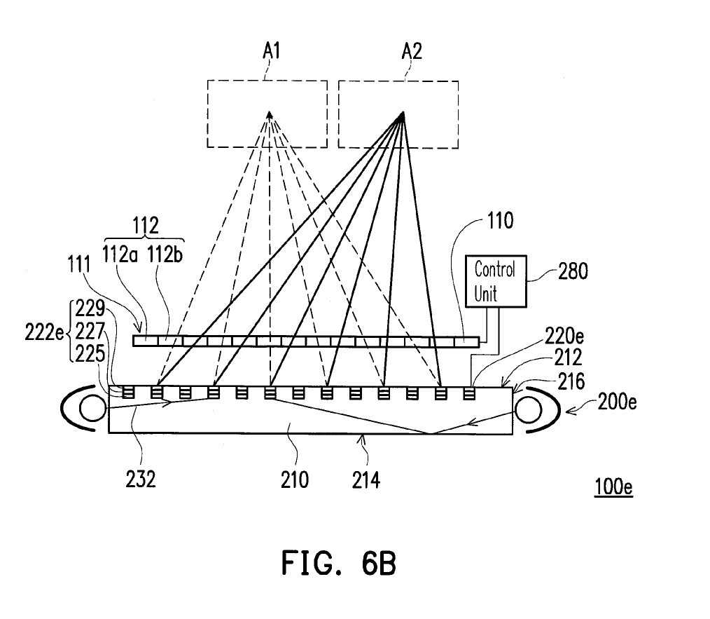

FIGS. 6A and 6B are schematic view diagrams of a display apparatus according to another exemplary embodiment of the disclosure, wherein FIGS. 6A and 6B respectively illustrate the transmission path of the illumination light at two different time points in a frame time of the displace device. Referring to FIGS. 6A and 6B, the displace apparatus 100e of this exemplary embodiment is similar to the display apparatus 100 of FIG. 1A. The difference between the two display apparatuses is discussed below. In the backlight module 200e of the display apparatus 100e of this exemplary embodiment, the patterned electric-variable light scattering structures 220e are used to replace the patterned light scattering structure 220 in the above exemplary embodiment (for example, the pattered light scattering structure 220 as illustrated in FIG. 1A), and the pitch of the patterned electric-variable light scattering structure 220e is adjusted according to the design requirements. Alternatively speaking, the patterned electric-variable light scattering structure 220e is disposed on the light guide plate 210 or inside the light guide plate 210. The patterned electric-variable light scattering structure 220e comprises a plurality of electric-variable light scattering strips 222e, and each electric-variable light scattering strip 222e is configured to switch between a scattered state and a transparent state according to variation of voltage applied on each electric-variable light scattering strip 222e. These electric-variable light scattering strips 222e are configured to be in a scattered state to scatter the illumination light 232.

In the exemplary embodiment, each electric-variable light scattering strip 222e comprises a first electrode layer 225, an electric-variable medium layer 227 and a second electrode layer 229. The first electrode layer 225 is disposed on the first surface 212 of the light guide plate 210, and the electric-variable medium layer 227 is disposed on the first electrode layer 225 and between the first electrode layer 225 and the second electrode layer 229. The electric-variable medium layer 227 is configured to switch between a scattered state and a transparent state according to variation of voltage applied on the electric-variable medium layer 227. Further, in this exemplary embodiment, the electric-variable medium layer 227 is, for example, polymer dispersed liquid crystal (PDLC) layer. Accordingly, when there is no voltage difference between the first electrode layer 225 and the second electrode layer 229, the electric-variable medium layer 227 is in a scattered state for the electric-variable light scattering strips 222e to be in a scattered state. When there is a voltage difference between the first electrode layer 225 and the second electrode layer 229 which is greater than a certain degree, the electric-variable medium layer 227 is in a transparent state for the electric-variable light scattering strips 222e to be in a transparent state.

In another exemplary embodiment, the electric-variable medium layer 227 is for example, a polymer stabilized cholesteric texture (PSCT) liquid crystal. Accordingly, when there is no voltage difference between the first electrode layer 225 and the second electrode layer 229, the electric-variable medium layer 227 is in a transparent state for the electric-variable light scattering strips 222e to be in a transparent state. When there is a voltage difference between the first electrode layer 225 and the second electrode layer 229 which is greater than a certain degree, the electric-variable medium layer 227 is in a scattered state for the electric-variable light scattering strips 222e to be in a scattered state.

In this exemplary embodiment, the display apparatus 100e further comprises a control unit 280, electrically connected to the patterned electric-variable light scattering structures 220e and the transmissive display panel 110, to coordinate the action of the patterned electric-variable light scattering structures 220e with the image displayed by the transmissive display panel 110. More specifically, the control unit 280 divides these electric-variable light scattering strips 222e into N groups of electric-variable light scattering strips 222e, wherein N is a positive integer greater than or equal to 2 (in FIGS. 6A and 6B, N is equal to 2, for example). In each group of electric-variable light scattering strips 222e, N-1 electric-variable light scattering strips of the other N-1 group electric-variable light scattering strips are configured in between two neighboring electric-variable light scattering strips 222e in each group of electric-variable light scattering strips. The control unit 280 in FIG. 6A divides these electric-variable light scattering strips 222e into two groups of electric-variable light scattering strips 222e. More specifically, when counting from the left in FIGS. 6A and 6B, the odd numbered electric-variable light scattering strips 222e form one group of electric-variable light scattering strips 222e, while the even numbered electric-variable light scattering strips 222e form another group of electric-variable light scattering strips 222e. In other words, the above two groups of electric-variable light scattering strips 222e are alternately arranged on the light guide plate 210. Hence, in each group of electric-variable light scattering strips 222e as shown in FIGS. 6A and 6B, two neighboring electric-variable light scattering strips 222e in each group of the electric-variable light scattering strips 222e are disposed with an electric-variable light scattering strip 222e of another group of electric-variable light scattering strips 222e in between. Moreover, the control unit 28 controls the N groups of the electric-variable light scattering strips 222e to take turns to be in a scattered state. In FIGS. 6A and 6B, the two groups of electric-variable light scattering strips 222e are alternately in the scattered state.

The transmissive display panel 110 comprises a plurality of pixel groups 111, and each pixel group 111 comprises a plurality of pixel columns 112. These pixel groups 111 are M pixel groups 111, for example, wherein M is a positive integer greater than or equal to 2. In each pixel group, M-1 pixel columns 112 belonging to other M-1 pixel groups 111 are configured in between two neighboring pixel columns 112. In this exemplary embodiment, M=2, which implies the transmissive display panel 110 may comprise two pixel groups, wherein all the pixel columns 112a on the transmissive display panel 110 form one group, and all the pixel columns 112b on the transmissive display panel 110 form another group, and the pixel column 112a and the pixel column 112b are alternately arranged. In this exemplary embodiment, the pitch (the cycle) P1′ of the electric-variable light scattering strips 222e is approximately greater than the pitch (the cycle) P2′ of the pixel column 112.

When any one group of the electric-variable light scattering strips 222e is in a scattered state, the illumination light 232 emitted by this group of electric-variable light scattering strips 222e, after passing through the pixel groups 111a, 111b, is respectively converged at a plurality of viewing zones A1 and A2. For example, when the display apparatus 100e is in a scattered state as illustrated in FIG. 6A, the group of the electric-variable light scattering strips 222e of the odd numbered columns, when counting from the left of FIG. 6A, is in a scattered state. Hence, the illumination light 232 is scattered to the transmissive display panel 110. Further, the group of the electric-variable light scattering strips 222e of the even numbered columns, when counting from the left of FIG. 6A, is in a transparent state, and the illumination light 232 is not being scattered out of the light guide plate 210. Moreover, when the display apparatus 100e is in a state as illustrated in FIG. 6B, the group of electric-variable light scattering strips 222e of the even numbered column, when counting from the left in FIG. 6B, is in a scattered state. Hence, the illumination light 232 is scattered to the transmissive display panel 110. Whereas, when the group of electric-variable light scattering strips 222e of the odd numbered column, when counting from the left in FIG. 6B, is in a transparent state, the illumination light 232 is unable to be scattered out of the light guide plate 210.

In the exemplary embodiment, in a meantime, the control unit 280 allows M pixel groups to respectively display 1/N of an image of the M different viewing angels. For example, when the display apparatus 100e is in the state as shown in FIG. 6A, the pixel columns 112a display half the image of the viewing zone A1, and the pixel columns 12b display half the image of the viewing zone A2. When the display apparatus 100e is in the state as shown in FIG. 6B, the pixel columns 112a display another half of the image of the viewing zone A2, while the pixel columns 112b display another half of the image of the viewing zone A1. When the display apparatus 100e alternates in the states as shown in FIG. 6A and FIG. 6B, the display apparatus 100e can provide a full-resolution image. In other words, the image displayed by the pixel column 112a as shown in FIG. 6A plus the image displayed by the pixel columns 112b as shown in FIG. 6B composes a full-resolution image that is being transmitted to the viewing zone A1, while the image displayed by the pixel column 112b as shown in FIG. 6A plus the image displayed by the pixel columns 112a as shown in FIG. 6B composes a full-resolution image that is being transmitted to the viewing zone A2. Alternatively speaking, the display apparatus 100e may apply a temporal multiplexing display mode to achieve the display of a full-resolution stereoscopic image.

Moreover, the positions at which the patterned light scattering structure 220 is configured, as discussed in the above exemplary embodiment, may also be used for disposing the patterned electric-variable light scattering structure 220e of this exemplary embodiment. Alternatively speaking, the patterned electric-variable light scattering structure 220e may be disposed on the first surface 212 or the second surface 214, or may be disposed between the first surface 212 and the second surface 214. Moreover, in this exemplary embodiment, each electric-variable light scattering strip 222e comprises a plurality of electric-variable light scattering patterns arranged on a straight line and being spaced apart. Hence, these electric-variable light scattering patterns may be used to replace the light scattering patterns 223 in FIG. 1B. Accordingly, the method of arrangement is the same as that of the light scattering patterns 223 in FIG. 1B. In other words, in this exemplary embodiment, for the electric-variable light scattering strips 222e that are farther away from the light emitting device 230, the number density of the electric-variable light scattering patterns is higher. Further, in this exemplary embodiment, these electric-variable light scattering strips 222e are configured in equal intervals. Moreover, each electric-variable light scattering pattern of each electric-variable light scattering strip 222e is formed with a portion of the first electrode layer 225, a portion of the electric-variable medium layer 227, and a portion of the second electrode layer 229.

In other exemplary embodiments, the patterned light scattering structures 220 in FIG. 3 may be replaced by the patterned electric-variable light scattering structures 222e, and the patterned light scattering structures 220 in FIG. 4 may be replaced by the patterned electric-variable light scattering structures 222e to form another two types of backlight module.

In this exemplary embodiment, these electric-variable light scattering strips 222e and these pixel columns 112 are substantially parallel to each other. However, in other exemplary embodiments, these electric-variable light scattering strips 222e may be inclined with respect to the pixel columns 112, and the degree of inclination of the electric-variable light scattering strips 222e may refer to the degree of inclination of the light scattering strips 222a in FIG. 2.

In another exemplary embodiment, the control unit 280 controls these electric-variable light scattering strips 222e to be in a scattered state simultaneously. The pitch (cycle) P1′ of these electric-variable light scattering strips 222e is approximately two times the pitch (cycle) P2′ of the pixel columns 112, and the illumination light 232 scattered by these electric-variable light scattering strips 222e, after passing through these pixel groups 111, is respectively converged at a plurality of viewing zones. This situation is similar to replacing the light scattering strips 222 in FIG. 1A with the electric-variable light scattering strips 222e, and the pitch of the electric-variable light scattering strips 222e is the same as that illustrated in FIG. 1A. Moreover, the control unit 280 controls the M pixel groups 111 to respectively display the images of M different viewing angles. When these electric-variable light scattering strips 222e are simultaneously in a scattered stated, a spatial multiplexing stereoscopic display effect is generated as that generated by the display apparatus in FIG. 1A.

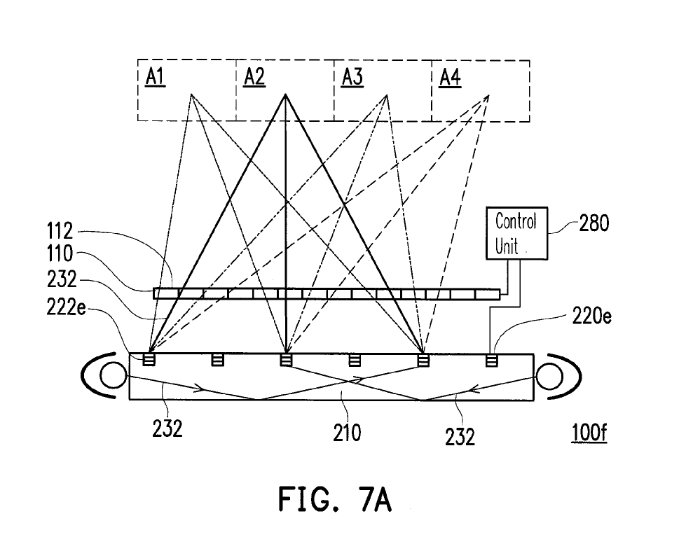

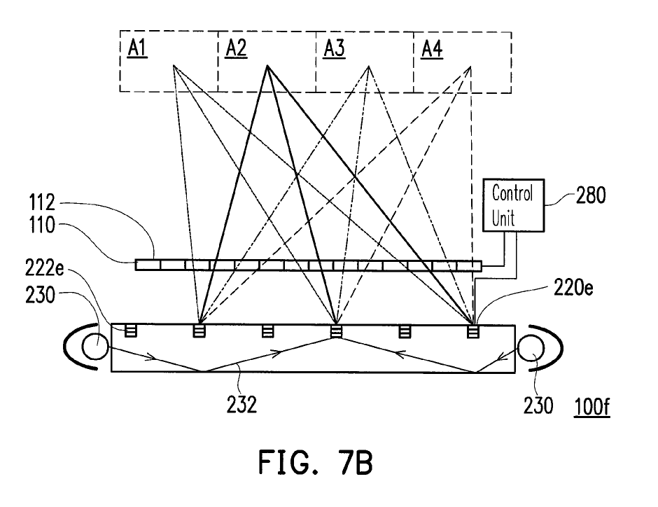

FIGS. 7A and 7B are cross-sectional view diagrams of a display apparatus according to another exemplary embodiment of the disclosure. FIGS. 7A and 7B respectively illustrate the transmission path of the illumination light at two different time points in a frame time of a display apparatus. The display apparatus 100f in FIGS. 7A and 7B is similar to the display apparatus 100e in FIGS. 6A and 6B. The difference between the two apparatuses is discussed below. The display apparatus 100e in FIGS. 6A and 6B comprises a temporal multiplexing display mode, and the display apparatus 100f of this exemplary embodiment has a temporal and spatial hybrid multiplexing display mode. More specifically, in this exemplary embodiment, the odd-numbered columns of electric-variable light scattering strips 222e, when counting from the left side of Figure, are in a scattered state (as shown in FIG. 7A), these odd-numbered columns of electric-variable light scattering strips 222e scatter the illumination light 232 to the transmissive display panel 110, and the illumination light 232 respectively transmits the images generated by the M pixel groups to the M viewing zones. In this exemplary embodiment, M is 4, for example, and the illumination light 232 transmits the images, generated from the 4k-3^{th}, the 4k-2^{th}, the 4k-1^{th}, the 4k^{th} pixel columns, when counting from the left of the Figure, respectively, to the viewing zone A1, the viewing zone A2, the viewing zone A3, and the viewing zone A4, wherein k is a positive integer. On the other hand, when the even-numbered columns of electric-variable light scattering strips 222e, when counting form the left of the figure, are in a scattered state (as illustrated in FIG. 7B), these even number columns of electric-variable light scattering strips 222e scatter the illumination light 232 to the transmissive display panel 110, and the illumination light 232 respectively transmits the images of the M pixel groups to the M viewing zones. In this exemplary embodiment, M is 4, for example, and the illumination light 232 transmits the images, generated from the 4k-1^{th}, the 4k^{th}, the 4k-3^{th}, and the 4k-2^{th} pixel columns 112 when counting from the left of the Figure, respectively to the viewing zone A1, the viewing zone A2, the viewing zone A3, and the viewing zone A4. After one frame time, during which the two states of FIGS. 7A and 7B occur, the images generated from the 4k-3^{th} pixel column 112 in the state of FIG. 7A and the 4k-1^{th} pixel column 112 in the state of FIG. 7B form the images in the viewing zone A1, the images generated from the 4k-2^{th} pixel column 112 in the state of FIG. 7A and the 4k^{th} pixel column 112 in the state of FIG. 7B form the images in the viewing zone A2, the images generated from the 4k-1^{th} pixel column 112 in the state of FIG. 7A and the 4k-3^{th} pixel column 112 in the state of FIG. 7B form the images in the viewing zone A3, and the images generated by the 4k^{th} pixel column 112 in the state of FIG. 7A and the 4k-2^{th} pixel column in the state of FIG. 7B form the images in the viewing zone A4. Accordingly, the image generated in each viewing zone A1 uses a half of the resolution of the transmissive display panel 110 and the image in each viewing zone A1 is formed by the image generated by the state in FIG. 7A and the image generated by the state in FIG. 7B. Hence, the display apparatus 100f of this exemplary embodiment has a hybrid type of multiplexing display mode with two times the temporal multiplexing and two times the spatial multiplexing.

Moreover, the two neighboring pixel columns 112 in each pixel group 111 are respectively disposed therebetween with M-1 pixel columns 112 of another M-1 pixel groups. For example, when M=4, all the above 4k-3^{th} (for example, the first, the fifth, the ninth, etc.) pixel columns 112 form the pixel group 111, and the above 4k-2^{th} (for example, the second, the sixth, the tenth, etc.) pixel columns 112 form another pixel group 111, and all the above 4k-1^{th} (for example, the third, the seventh, the eleventh, etc.) pixel columns 112 form another pixel group 111, and the above 4k^{th} (for example, the fourth, the eighth, the twelfth, etc.) pixel columns 112 form another pixel group 111. Accordingly, there are four pixel groups. The two neighboring 4k-1^{th} pixel columns 112 are disposed with, one of the 4k^{th} pixel columns 112, one of the 4k-3^{th} pixel columns 112, one of the 4k-2^{th} pixel columns 112, etc., a total of three other pixel columns in between. More specifically, the neighboring third (in which K=1 is substituted into 4K-1 to obtain 3) pixel column 112 and seventh (in which K=2 is substituted into 4K-1 to obtain 7) pixel column 112 (the third and the seventh belong to this 4K-1 pixel group 111) are disposed with the fourth pixel column 112 (belong to 4K pixel group 111), the fifth pixel column 112 (belonging to the 4K-3 pixel group 111, and the sixth pixel column 112 (belonging to 4K-1 pixel group 111) in between, which is a total of three (in which M=4 is substituted into M-1 to obtain 3) pixel columns 112. The three pixel columns 112 respectively belong to three other groups (the other three groups, different from the 4K-1 group).

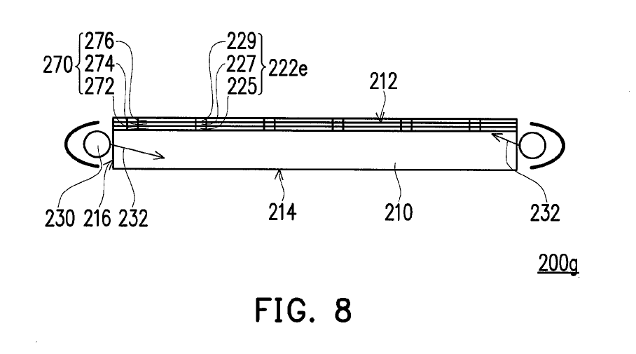

FIG. 8 is a cross-sectional view diagram of a backlight module according to another exemplary embodiment of the disclosure. Referring to FIG. 8, the backlight module 220g of this exemplary embodiment is similar to the backlight module in FIG. 6B. The difference between the two modules is discussed below. The backlight module 200g of this exemplary embodiment further comprises the electric-variable light scattering structure 270 as described in the exemplary embodiment of FIG. 5. Comparing to the exemplary embodiment in FIG. 5, the electric-variable light scattering structure 270 of this exemplary embodiment is disposed on or inside the light guide plate 210. Moreover, the electric-variable light scattering structure 270 is at least distributed in the region other than the patterned electric-variable light scattering structure 220 (a plurality of electric-variable light scattering strips 222e). The electric light scattering structure 270 is configured to switch between a scattered state and a transparent state according to variation of voltage applied thereon. When the electric-variable light scattering structure 270 is in a scattered state, the display apparatus is in a 2-dimensional image display mode. When the electric-variable light scattering structure 270 is in a transparent state, the display apparatus is in a three-dimensional image display mode. Moreover, when a portion of the electric-variable light scattering structure 270 is in the scattered state, while another portion of the electric-variable light scattering structure is in the transparent state, a region of the display apparatus is in a two-dimensional image display mode, while another region of the display apparatus is in a three-dimensional display mode.

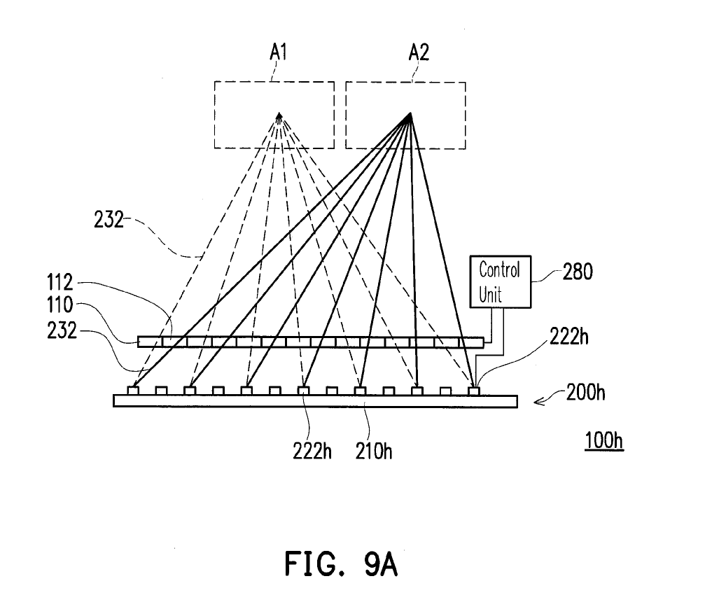

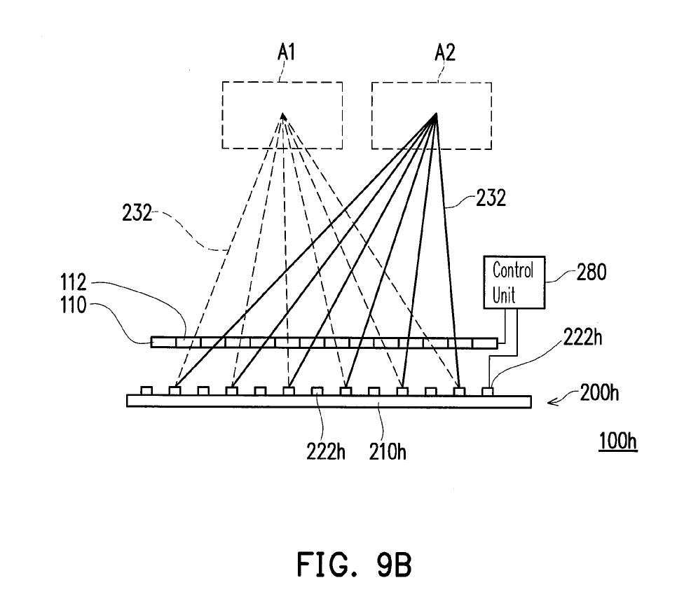

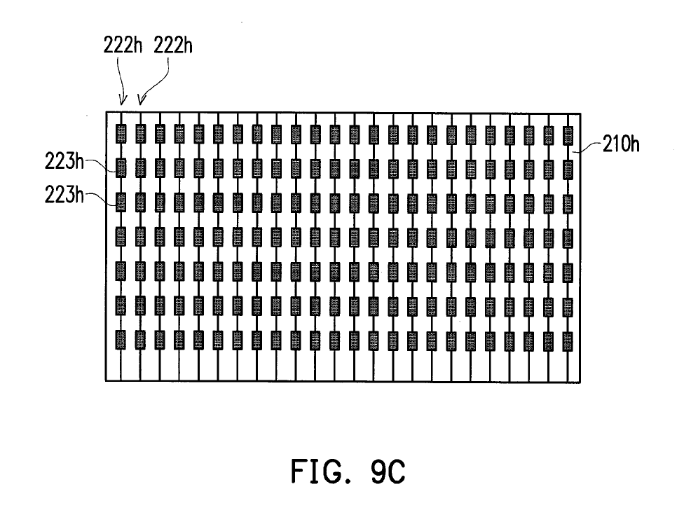

FIGS. 9A and 9B are schematic, cross-sectional view diagrams of a display apparatus according to another exemplary embodiment of the disclosure, wherein FIGS. 9A and 9B respectively illustrate the transmission path of the illumination light at two different time points in a frame time of the displace device. FIG. 9C is a top view diagram of the backlight module in FIGS. 9A and 9B. Referring to FIGS. 9A to 9C, the display apparatus 100h of this exemplary embodiment is similar to the display apparatus 100e in FIGS. 6A and 6B. The difference between the two apparatuses is discussed below. In this exemplary embodiment, the backlight module 200h of the display apparatus 100h is a direct backlight module, which comprises a substrate 210h and a plurality of light self-emitting structures 222h. The light self-emitting structures 222h are disposed on the substrate 210h, and are used for emitting an illumination light 232. In this exemplary embodiment, each light self-emitting structure 222h is a light emitting diode or an organic light emitting diode. In this exemplary embodiment, the light self-emitting structures 222h are disposed at the positions the same as the positions of the electric-variable light scattering strips 222e shown in FIG. 6A. The effect generated by the light emission of the light self-emitting structures 222h is substantially similar to the effect generated by the electric-variable light scattering strips 222e being in a scattered state and the illumination light being scattered. The effect generated by the light emission of the light self-emitting structures 222h is substantially similar to the effect generated by the electric-variable light scattering strips 222e being in a scattered state and the illumination light being scattered. The effect generated by the light self-emitting structures 222h not emitting light is substantially similar to the effect generated by the electric-variable light scattering strips 222e being in a transparent state and the illumination light not being scattered. The difference between the instant exemplary embodiment and the electric-variable light scattering strips 222e in FIG. 6A is that each light self-emitting structure 222h in this exemplary embodiment comprises a plurality of light emitting patterns 223h arranged along a straight line and spaced apart. In the instant exemplary embodiment, the light emitting patterns 223h are disposed spaced apart in equal intervals such that the illumination light provided by the light self-emitting structures 222h is more uniform. Further, each light self-emitting structure 222h is, for example, a light emitting diode or an organic light emitting diode. In this exemplary embodiment, these light self-emitting structures 222h and these pixel columns 112 are substantially parallel to each other. However, in other exemplary embodiments, these light self-emitting structures 222h are inclined with respect to these pixel columns 112, similar to the inclined light scattering strips 222a in FIG. 2a with respect to the pixel columns 112.

The coordination of the light emitting action mode or the non-light emitting action mode of the light self-emitting structures 222h with the display state of each pixel column 112 of the transmissive display panel 110 may refer to the coordination of the action mode of the electric-variable light scattering strips 222e in a scattered state or in a transparent state with the display state of each pixel column 112 of the transmissive display panel 110 as shown in the exemplary embodiment in FIGS. 6A and 6B. The details of the above action modes and coordination methods are omitted herein. Alternatively speaking, the control unit 280 is electrically connected to these light self-emitting structures 222h and the transmissive display panel 110, wherein the control unit 280 divides these light self-emitting structures 222h into N groups of light self-emitting structures 222h, wherein N is a positive integer. Moreover, the transmissive display panel 110 comprises a plurality of pixel groups 111, and each pixel group 111 comprises a plurality of pixel columns 112. Further, the illumination light 232 emitted from each group of the light self-emitting structures 222h, after passing through these pixel groups 111, is converged at a plurality of viewing zones A1, A2, respectively.

In this exemplary embodiment, the control unit 280 coordinates the light-emitting timings of these light self-emitting structures 222h with the image displayed by the transmissive display panel. More specifically, in this exemplary embodiment, N is a positive integer greater than or equal to 2, and the two neighboring light self-emitting structures 222h in each group of light self-emitting structures 222h are disposed therebetween with N-1 light self-emitting structures 222h of the other N-1 groups of light self-emitting structures 222h. Further, the control unit 280 controls the N groups of light self-emitting structures 222h to take turns in emitting light. In other words, the display apparatus 100h may generate a temporal multiplexing stereoscopic display mode. However, in another exemplary embodiment, these light self-emitting structures 222h may be disposed at the positions the same as the positions of the light self-emitting scattering strips 222h shown in FIG. 1A. Moreover, N=1, and the control unit 280 controls theses light self-emitting structures 222h to emit light concurrently. The illumination light 232, emitted from these light self-emitting structures 222h, is converged at a plurality of viewing zones A1, A2 (as illustrated in FIG. 1A), respectively after passing through the pixel groups 111. Alternatively speaking, this display apparatus may generate a spatial multiplexing stereoscopic display mode.

In another exemplary embodiment, the light self-emitting structures 222h are disposed at the positions the same as the positions of the electric-variable light scattering strips 222e in FIGS. 7A and 7B. The coordination of the light emitting or non-light emitting action mode of the light self-emitting structures 222h with the display state of each pixel column 112 of the transmissive display panel 110 may refer to the coordination of the action mode of the electric-variable light scattering strips 222e in a scattered state or a transparent state with the display state of each pixel column 112 of the transmissive display panel 110. The details of the above coordination methods and the action modes are omitted herein. Alternatively speaking, this display apparatus may generate a stereoscopic display mode comprising temporal multiplexing and spatial multiplexing.

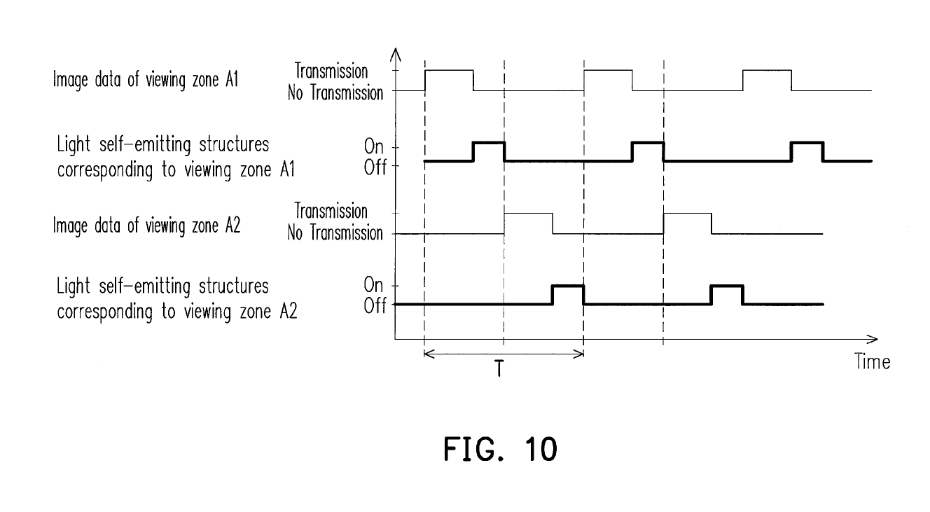

FIG. 10 is a wave diagram of another exemplary embodiment of the display apparatus in FIGS. 9A and 9B. Referring to FIGS. 9A, 9B and 10, in this exemplary embodiment, the light self-emitting structures 222h may be divided into multiple groups of light self-emitting structures 222h corresponding to a plurality of different viewing zones, for example, the light self-emitting structures 222h may be divided into the light self-emitting structures 222h corresponding to the viewing zone A1 and the light self-emitting structures 222h corresponding to the viewing zone A2. In each frame time T, the image data corresponding to the image in the viewing zone A1 is transmitted to the corresponding pixel columns 112. Then, this image data is no longer being transmitted. In the meantime, the liquid crystal molecules of the pixel columns 112 are maintained in a state corresponding to this image data. Thereafter, the light self-emitting structures 222h corresponding to the viewing zone A1 are turned on, and the illumination light 232 emitted from the light self-emitting structures 222h corresponding to the viewing zone A1 transmits the image of the viewing zone A1 to the viewing zone A1. Then, the light self-emitting structures 222h corresponding to the viewing zone A1 are turned off, and the image data corresponding to the image in the viewing zone A2 is first transmitted to the corresponding pixel columns 112. Then, this image data is no longer being transmitted; but in the meantime, the liquid crystal molecules of the pixel columns 112 maintain the state corresponding to this image data. Thereafter, the light self-emitting structures 222h of the corresponding viewing zone A2 are turned on, and the illumination light 232 emitted from the light self-emitting structures 222h corresponding to the viewing zones A2 transmits the image of the viewing zone A2 to the viewing zone A2. Accordingly, images of different viewing angles are generated at different viewing zones to achieve the stereoscopic effect.

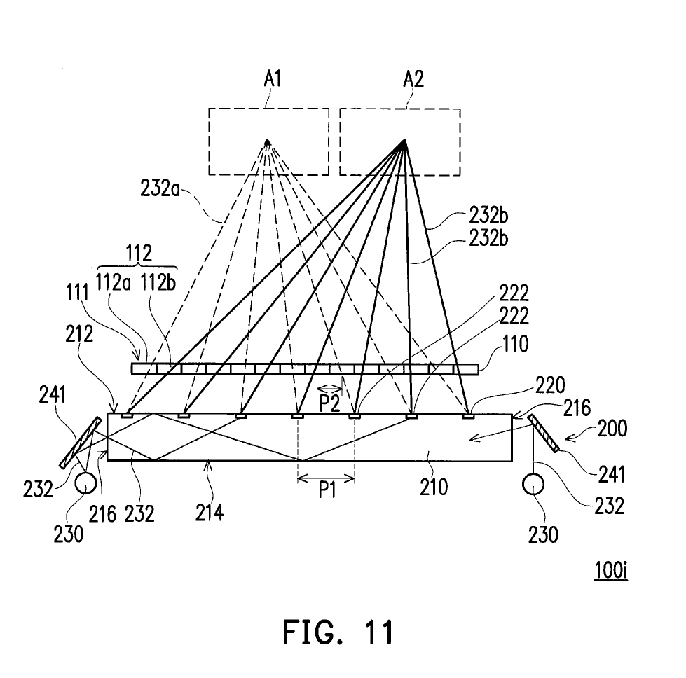

FIG. 11 is a schematic cross-sectional diagram of a display apparatus according to another exemplary embodiment of the disclosure. Referring to FIG. 11, the display apparatus 110i of this exemplary embodiment is similar to the display apparatus 100 in FIG. 1A. The difference between the two apparatuses is discussed below. In the exemplary embodiment of FIG. 1A, the light emitting device 230, for example, is disposed directly in front of the light incident surface 216. However, in this exemplary embodiment, the light emitting device 230 is configured at other positions, for example, obliquely in front of the light incident surface 216. Moreover, a reflective device or other optical coupling device may be applied to guide the illumination light 232 emitted form the light emitting device 230 located at other positions to the light incident surface 216. In this exemplary embodiment, after the illumination light 232 is emitted from the light emitting device 230 and reflected by the reflective device 241, it enters the light guide plate 210 through the light incident surface 216. The reflective device 241 is, for example, a reflective mirror.

Accordingly, the display apparatus of the exemplary embodiments of the disclosure applies light scattering strips, and not the parallax barrier, to form a line shape light source for generating the stereoscopic display effect. The brightness of the stereoscopic image generated by the display apparatus is higher than that generated by a parallax barrier, and the decay problem of image brightness due to the light shielding effect of the parallax barrier is obviated. Moreover, in the display apparatus of the exemplary embodiment of the disclosure, patterned electric-variable light scattering structures or light self-emitting structures are used to form the line shape light source. Hence, spatial multiplexing display mode or temporal multiplexing display mode, or a hybrid display mode of having spatial multiplexing display and temporal multiplexing display mode is achieved. Further, the display apparatus of the exemplary embodiments of the disclosure may also comprise an electric-variable light scattering structure; hence, the display apparatus may switch between a three-dimensional display mode and a two-dimensional display mode.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display apparatus, comprising:
a backlight module, comprising:
a light guide plate, comprising a first surface, a second surface opposite to the first surface, and a light incident surface connecting the first surface and the second surface;
a patterned light scattering structure, disposed over the light guide plate or inside the light guide plate, wherein the patterned light scattering structure comprises a plurality of light scattering strips;
a light emitting device, configured to emit an illumination light, wherein the light incident surface is disposed on a transmission path of the illumination light, and the plurality of light scattering strips is used to scatter the illumination light; and
a transmissive display panel, disposed on one side of the backlight module, wherein the first surface faces towards the transmissive display panel, and the transmissive display panel comprises a plurality of pixel groups, each of the plurality of pixel groups comprises a plurality of pixel columns, and the illumination light, after being scattered by the plurality of light scattering strips and passing through the plurality of pixel groups, is respectively converged at a plurality of viewing zones.

2. The display apparatus of claim 1, wherein the patterned light scattering structure is disposed on the first surface or the second surface.

3. The display apparatus of claim 1, wherein the patterned light scattering structure is disposed between the first surface and the second surface.

4. The display apparatus of claim 1, wherein each of the plurality of light scattering strips comprises a plurality of light scattering patterns arranged on a straight line and spaced apart.

5. The display apparatus of claim 4, wherein for the plurality of light scattering strips that is farther away from the light emitting device, a number density of the plurality of light scattering patterns is higher.

6. The display apparatus of claim 1, wherein the plurality of light scattering strips is disposed in equal intervals.

7. The display apparatus of claim 1, wherein the illumination light scattered by the plurality of light scattering strips is converged to a same viewing zone of the plurality of viewing zones after passing through a same pixel group of the plurality of pixel groups.

8. The display apparatus of claim 1, wherein the backlight module comprises a reflection sheet, covering the first surface and the reflection sheet comprises a plurality of transparent openings to respectively expose the plurality of light scattering strips.

9. The display apparatus of claim 1, wherein the backlight module further comprises a reflection sheet, covering the first surface, and the reflection sheet comprises a patterned reflection region and a patterned transparent region, the patterned reflection region covers a region other than a location of the patterned light scattering structure of the light guide plate, and the patterned transparent region faces directly towards the patterned light scattering structure.

10. The display apparatus of claim 1 further comprising an electric-variable light scattering structure, disposed over or inside of the light guide plate, wherein the electric-variable light scattering structure is distributed at least in a region of the light guide plate other than the patterned light scattering structure, and the electric-variable light scattering structure is configured to switch between a scattered state and a transparent state with variation of voltage applied on the electric-variable light scattering structure, and when the electric-variable light scattering structure is in the scattered state, the display apparatus is in a two-dimensional image display mode, and when the electric-variable light scattering structure is in the transparent state, the display apparatus is in a three-dimensional image display mode, and when a portion of the electric-variable light scattering structure is in a scattered state while another portion of the electric-variable light scattering structure is in the transparent state, a region of the display apparatus is in the two-dimensional image display mode and another region of the display apparatus in the three-dimensional image display mode.

11. The display apparatus of claim 1, wherein the plurality of pixel groups is M pixel groups, and M is a positive integer greater than or equal to two, and two neighboring pixel columns of the plurality of pixel columns in the each of the plurality of pixel groups are disposed therebetween with M-1 pixel columns of the plurality of pixel columns of other M-1 pixel groups of the plurality of pixel groups.

12. The display apparatus of claim 11, wherein the M pixel groups of the plurality of pixel groups respectively display M images of different viewing angles of the plurality of viewing angles.

13. The display apparatus of claim 1, wherein the plurality of light scattering strips is substantially parallel to or is inclined with respect to the plurality of pixel columns.

14. The display apparatus of claim 1, wherein the backlight module further comprises a reflective device, disposed on the transmission path of the illumination light, for reflecting light beams of the illumination light from the light emitting device to the light incident surface.

15. The display apparatus of claim 1, wherein each of the plurality of light scattering strips comprises light scattering particles, a holographic scattering structure, a surface microstructure, a light scattering layer or a combination thereof.

16. A display apparatus, comprising:
a backlight module, comprising:
a light guide plate, comprising a first surface, a second surface opposite to the first surface, and a light incident surface connecting the first surface and the second surface;
a patterned electric-variable light scattering structure, disposed over the light guide plate or inside the light guide plate, wherein the patterned electric-variable light scattering structure comprises a plurality of electric-variable light scattering strips, and each of the plurality of electric-variable scattering strips is configured to switch between a scattered state and a transparent state with variation of voltage applied on the each of the plurality of electric-variable scattering strips;
a light emitting device, configured to emit an illumination light, wherein the light incident surface is disposed on a transmission path of the illumination light, and the plurality of electric-variable scattering strips is in the scattered state to scatter the illumination light; and
a transmissive display panel, disposed on one side of the backlight module, wherein the first surface faces towards the transmissive display panel.

17. The display apparatus of claim 16 further comprising a control unit electrically connected to the patterned electric-variable light scattering structure and the transmissive display panel to coordinate an action of the patterned electric-variable light scattering structure with an image displayed by the transmissive display panel.

18. The display apparatus of claim 17, wherein the control unit divides the plurality of electric-variable light scattering strips into N groups of electric-variable light scattering strips, N is greater than or equal to two, and two neighboring electric-variable light scattering strips of the plurality of electric-variable light scattering strips of each group of the N groups of electric-variable light scattering strips are disposed therebetween with other N-1 electric-variable light scattering strips of the plurality of electric-variable light scattering strips of other N-1 groups of the N groups of the electric-variable light scattering strips, and the control unit controls the N groups of electric-variable light scattering strips to take turns to be in the scattered state, and the transmissive display panel comprises a plurality of pixel groups, each of the plurality of pixel groups comprises a plurality of pixel columns, and when any one group of the N groups of the electric-variable light scattering strips is in the scattered state, the illumination light scattered by the any one group of the N groups of electric-variable light scattering strips is respectively converged at a plurality of viewing zones after passing through the plurality of pixel groups.

19. The display apparatus of claim 18, wherein the plurality of pixel groups is M pixel groups, wherein M is a positive integer greater than or equal to 2, and two neighboring pixel columns of the plurality of pixel columns in each pixel group of the M pixel groups are disposed therebetween with M-1 pixel columns of the plurality of pixel columns respectively belonging to other M-1 pixel groups of the M pixel groups.

20. The display apparatus of claim 19, wherein within a same time, the control unit controls the M pixel groups of the plurality of pixel groups to respectively display an 1/N image of M different viewing angles.

21. The display apparatus of claim 17, wherein the control unit controls the plurality of light scattering strips to be in the scattered state simultaneously, and the transmissive display panel comprises a plurality of pixel groups, each of the plurality of pixel groups comprises a plurality of pixel columns, and the illumination light scattered by the plurality of electric-variable light scattering strips respectively converges at a plurality of viewing zones after passing through the plurality of pixel groups.

22. The display apparatus of claim 21, wherein the plurality of pixel groups is M pixel groups, wherein M is a positive integer greater than or equal to 2, and two neighboring pixel columns of the plurality of pixel columns in each pixel group of the M pixel groups are disposed therebetween with M-1 pixel columns of the plurality of pixel columns respectively belonging to other M-1 pixel groups of the M pixel groups.

23. The display apparatus of claim 22, wherein the control unit controls the M pixel groups to respectively display images of M different viewing angles.

24. The display apparatus of claim 16, wherein the patterned electric-variable light scattering structure is disposed over the first surface or the second surface.

25. The display apparatus of claim 16, wherein the patterned electric-variable light scattering structure is disposed between the first surface and the second surface.

26. The display apparatus of claim 16, wherein the each of the plurality of electric-variable scattering strips comprises a plurality of electric-variable light scattering patterns arranged on a straight line and spaced apart.

27. The display apparatus of claim 26, wherein for the plurality of electric-variable light scattering patterns that is farther away from the light emitting device, a number density of the plurality of light scattering strips is higher.

28. The display apparatus of claim 16, wherein the plurality of electric-variable light scattering strips is disposed in equal intervals.

29. The display apparatus of claim 16, wherein the backlight module comprises a reflection sheet covering the first surface, and the reflection sheet comprises a plurality of transparent openings to respectively expose the plurality of electric-variable light scattering strips.

30. The display apparatus of claim 16, wherein the backlight module further comprises a reflection sheet, covering the first surface, and the reflection sheet comprises a patterned reflection region and a patterned transparent region, the patterned reflection region covers a region other than a location of the patterned electric-variable light scattering structure of the light guide plate, and the patterned transparent region faces directly towards the patterned electric-variable light scattering structure.

31. The display apparatus of claim 16 further comprising an electric-variable light scattering structure disposed over or inside of the light guide plate, wherein the electric-variable light scattering structure is distributed at least in a region of the light guide plate other than the patterned electric-variable light scattering structure, and the electric-variable light scattering structure is configured to switch between a scattered state and a transparent state with variation of voltage applied on the electric-variable light scattering structure, and when the electric-variable light scattering structure is in the scattered state, the display apparatus is in a two-dimensional image display mode, and when the electric-variable light scattering structure is in the transparent state, the display apparatus is in a three-dimensional image display mode, and when a portion of the electric-variable light scattering structure is in the scattered state while another portion of the electric-variable light scattering structure is in the transparent state, a region of the display apparatus is in the two-dimensional image display mode and another region of the display apparatus is in the three-dimensional image display mode.

32. The display apparatus of claim 16, wherein the plurality of electric-variable light scattering strips is substantially parallel to or is inclined with respect to the plurality of pixel columns.

33. The display apparatus of claim 16, wherein the backlight module further comprises a reflective device, disposed on the transmission path of the illumination light, for reflecting light beams of the illumination light from the light emitting device to the light incident surface.

34. A display apparatus comprising:
a backlight module, comprising:
a substrate; and
a plurality of light self-emitting structures disposed on the substrate and emitting an illumination light;
a transmissive display panel, disposed on one side of the backlight module; and
a control unit, electrically connected to the plurality of light self-emitting structures and the transmissive display panel, wherein the control unit divides the plurality of light self-emitting structures into N groups of light self-emitting structures, N is a positive integer, and the transmissive display panel comprises a plurality of pixel groups, and each of the plurality of pixel groups comprises a plurality of pixel columns, and the illumination light emitted by each of the plurality of light self-emitting structures is respectively converged at a plurality of viewing zones after passing through the plurality of pixel groups.

35. The display apparatus of claim 34, wherein the control unit coordinates a light emitting timing of the plurality of light self-emitting structures with an image displayed by the transmissive display panel.

36. The display apparatus of claim 35, wherein the N is the positive integer greater than or equal to 2, and two neighboring light self-emitting structures of the plurality of light self-emitting structures in each group of the N groups of light self-emitting structures are disposed therebetween with N-1 light self-emitting structures of the plurality of light self-emitting structures respectively belonging to other N-1 groups of the N groups of light self-emitting structures.

37. The display apparatus of claim 36, wherein the plurality of pixel groups is M pixel groups, M is a positive integer greater than or equal to 2, and two neighboring pixel columns of the plurality of pixel columns in each pixel group of the plurality of pixel groups are disposed therebetween with M-1 pixel columns of the plurality of pixel columns respectively belonging to other M-1 pixel groups of the M pixel groups.

38. The display apparatus of claim 37, wherein within a same time, the control unit controls the M pixel groups of the M pixel groups to respectively display an 1/N image of M different viewing angles.

39. The display apparatus of claim 34, wherein N=1, and the control unit controls the plurality of light emitting units to emit the illumination light simultaneously, and the illumination light emitted from the plurality of light self-emitting structures respectively converged at the plurality of viewing zones after passing through the plurality of pixel groups.

40. The display apparatus of claim 39, wherein the plurality of pixel groups is M pixel groups, M is a positive integer greater than or equal to 2, and two neighboring pixel columns of the plurality of pixel columns in each pixel group of the M pixel groups are disposed therebetween with M-1 pixel columns of the plurality of pixel columns respectively belonging to other M-1 pixel groups of the M pixel groups.

41. The display apparatus of claim 40, wherein the control units controls the M pixel groups to respectively display image of M different viewing angles.

42. The display apparatus of claim 34, wherein the each of the plurality of light self-emitting structures comprises a plurality of light emitting patterns arranged along a straight line and spaced apart.

43. The display apparatus of claim 34, wherein the plurality of light self-emitting structures is disposed in equal intervals.

44. The display apparatus of claim 34, wherein the plurality of light self-emitting structures is substantially parallel to or inclined with respect to the plurality of pixel columns.

45. The display apparatus of claim 34, wherein the each of the plurality of light self-emitting structures is a light-emitting diode or an organic light-emitting diode.
